(19) United States
(12) Patent Application Publication
(10) Pub. No.: US 2014/0242722 A1
(43) Pub. Date: Aug. 28, 2014

(54) ARTICLE AND METHOD FOR DETECTION OF A DRUG IN A LIQUID MEDIUM

(71) Applicants: Richard H. Knop, Beach Park, IL (US); Tiffany Griffin, Lynwood, IL (US); Victor Perez-Luna, Chicago, IL (US); William B. Leslie, Buffalo Grove, IL (US); Edward Johnson, Buffalo Grove, IL (US)

(72) Inventors: Richard H. Knop, Beach Park, IL (US); Tiffany Griffin, Lynwood, IL (US); Victor Perez-Luna, Chicago, IL (US); William B. Leslie, Buffalo Grove, IL (US); Edward Johnson, Buffalo Grove, IL (US)

(73) Assignee: MEDTECH DETECT, LLC, Buffalo Grove, IL (US)

(21) Appl. No.: 14/190,960

(22) Filed: Feb. 26, 2014

Related U.S. Application Data
(60) Provisional application No. 61/770,105, filed on Feb. 27, 2013.

(51) Int. Cl. G01N 21/78

(52) U.S. Cl. CPC G01N 21/78
USPC 436/501; 422/69; 422/419

(57) ABSTRACT

An article is provided for the detection of a drug in a liquid medium. The article includes a polymer having pores specifically imprinted to provide for capture of a drug in the pores, nanoparticles, and photochromic optical switch molecules. Capture of the drug in the pores of the polymer results in a change in the spatial relation of the nanoparticles in the polymer, causing the photochromic optical switch molecules to undergo a change in energy state which corresponds to a change in spectra of the photochromic optical switch molecules, thereby providing for detection of the drug.

### CROSS-REFERENCE TO RELATED APPLICATIONS

This application is based on, claims the benefit of, and incorporates herein by reference U.S. Provisional Application No. 61/770,105, filed Feb. 27, 2013.

### STATEMENT REGARDING FEDERALLY SPONSORED RESEARCH

Not applicable.

### FIELD OF THE DISCLOSURE

The present disclosure relates generally to an article and a method for the detection of a drug, such as a recreational or illicit drug, in a liquid sample, such as an alcoholic or non-alcoholic beverage.

### BACKGROUND OF THE INVENTION

Drug facilitated sexual assault, or more colloquially, “date rape,” often involves introducing recreational or illicit drugs into a liquid medium, such as an alcoholic beverage to be consumed by the intended victim. Some consumer products have been developed, including coasters on which a sample of the potentially adulterated liquid can be spotted for analysis. However, to date, these detection methods have been shown to be limited in the scope of detection and inaccurate depending on the concentration of drug and the liquid medium itself. Therefore, there is a need in society for an article or method to detect the presence of a drug in a liquid medium.

### SUMMARY OF THE INVENTION

The present disclosure provides an article for the detection of a drug in a liquid medium including a molecularly imprinted polymer. Molecularly imprinted polymers are polymers that have been traditionally used to filter and purify compounds during production processes. The polymers are formed in the presence of a molecule that is extracted afterwards, thus leaving behind cavities that are complementary to the extracted molecule. These polymers show a certain chemical affinity for the extracted molecule and thus can be used to fabricate sensors. According to one aspect, a molecularly imprinted polymer may be used as an article for the detection of a drug in a liquid medium. The article may be capable of producing a permanent and positive color change for detection of an analyte.

In one embodiment, the disclosure provides an article for the detection of a drug in a liquid medium. The article may include a polymer with pores imprinted to provide for capture of a drug in said pores, nanoparticles, and photochromic optical switch molecules. Capture of said drug in the pores of the polymer results in a change in the spatial relation of the nanoparticles in the polymer, causing the photochromic optical switch molecules to undergo a change in energy state which corresponds to a change in spectra of said photochromic optical switch molecules, thereby providing detection of the drug. In one aspect, the detection of said drug is provided by a color change of the article. In another aspect the pores are specifically imprinted to provide for capture of a recreational drug or illicit drug. In yet another aspect the drug is a depressant, an antihistamine, an analgesic, a tranquilizer, a hallucinogen, a psychedelic, a deliriant or a stimulant.

In another embodiment, the disclosure provides A method for the detection of illicit substances. The method includes contacting a sample with a drug in a liquid medium with an article. The article includes a polymer having pores specifically imprinted to provide for capture of a drug in the pores, nanoparticles, and photochromic optical switch molecules. A color change of the article indicates the presence of the drug in the liquid medium. In one aspect, the article is a straw, a beverage stirring bar, a cutlery, a beverage coaster, a placemat or a pen. In another aspect, the article is attached to a liquid medium carrier, a glass of beverage, a cup, a bowl, a dish, a straw, a beverage stirring bar, a cutlery, a cocktail napkin, a beverage coaster, a placemat, a menu, a personal card or a pen.

These and other aspects and advantages of the article and method disclosed herein will become better understood upon consideration of the detailed description.

### DETAILED DESCRIPTION OF THE INVENTION

### I. Definitions

Herein, an illicit drug is defined as an illegal or unlawful drug produced and sold outside of medical channels. Illicit drugs may include narcotics, stimulants, depressants (sedatives), hallucinogens and cannabis. A recreational drug is defined as a drug used with the intention of creating or enhancing a recreational experience. Drugs commonly considered capable of recreational use include alcohol, nicotine, caffeine, and drugs within the scope of the United Nations Single Convention on Narcotic Drugs and Convention on Psychotropic Substances.

### II. The Invention

One aspect of the disclosure provides for an article for the detection of a drug in a liquid medium. The article may include a polymer having pores specifically imprinted to provide for capture of a drug in the pores. The article may also include nanoparticles and photochromic optical switch molecules. Capture of the drug in the pores of the polymer can result in a change in the spatial relation of the nanoparticles in the polymer, causing the photochromic optical switch molecules to undergo a change in energy state which corresponds to a change in spectra of said photochromic optical switch molecules, thereby providing detection of the drug. Furthermore, the article may provide for detection of the drug by way of a color change.

In certain embodiments, the article may allow for the detection of a variety of drugs, including recreational or illicit drugs, by providing a polymer, wherein the pores are specifically imprinted to provide for capture of said recreational or illicit drugs. Examples of such types of drugs include a depressant, an antihistamine, an analgesic, a tranquilizer, a hallucinogen, a psychedelic, a deliriant or a stimulant. More specifically, the article may comprise a polymer with pores imprinted to provide for the capture of amobarbital, aprobarbital, alphenal, barbital, brallobarbital, phenobarbital, alprazolam, bretazenil, bromazepam, brotizolam, chlordiazepoxide, cinolazepam, clonazepam, clorazepate, clotiazepam, cloxazolam, delorazepam, diazepam, estazolam, etizolam, flurazepam, flutoprazepam, halazepam, ketazolam, loprazolam, lorazepam, lormetazepam, medazepam, midazolam, nimetazepam, nitrazepam, nordazepam, oxazepam, phenazepam, pinazepam, prazepam, premazepam, quazepam, temazepam, tetrazepam, triazolam, ipratropium bromide, oxitropium bromide, tiotropium, glycopyrrolate, oxybutinin, tolterodine, azelastine cetirizine, cyclizine, chlorpheniramine, clemastine, desloratadine, dexchlorpheniramine, dimenhydrinate, dimetindene, diphenhydramine, doxylamine, ebastine, embramine, fexofenadine, levocetirizine, loratadine, meclozine, olopatadine, pheniramine, promethazine, quetiapine, rupatadine, cimetidine, famotidine, lafutidine, nizatidine, ranitidine, roxatidine, paracetamol, or non-steroidal anti-inflammatory drugs (NSAIDs) in order to detect the aforementioned molecules.

In certain embodiments, the article may include a polymer with pores imprinted to provide for the capture of a benzodiazepine, nonbenzodiazepine, carisoprodol, chloral hydrate, diethyl ether, ethchlorvynol, gabapentin, gamma-butyrolactone (GBL), gamma-hydroxybutyrate (GHB), glutethimide, kava, kavalactones meprobamate, methaqualone, pregabalin, propofol, theanine, valerian, atropine, dimenhydrinate, diphenhydramine, hyoscyamine, scopolamine, myristicin, ibotenic acid, muscimol, dextromethorphan, dextromethorphan, chlorpheniramine, ketamine, methoxetamine, phencyclidine, nitrous oxide, phenethylamines, MDMA, mescaline, tryptamines, alpha-methyltryptamine, bufotenin, dimethyltryptamine, lysergic acid amide, lysergic acid diethylamide, psilocin, psilocybin, ibogaine, salvinorin A, sympathomimetics, Entactogens, arecoline, rauwolscine or yohimbine in order to detect the aforementioned molecules.

In certain other embodiments, the article may include a polymer with pores imprinted to provide for the capture of caffeine, tetrahydrocannabinol (THC), hydrocodone, oxycodone, morphine, diacetylmorphine, cocaine, lidocaine or novocaine in order to detect the aforementioned molecules.

In yet other embodiments, the article may include a polymer with pores imprinted to provide for the capture of gamma-hydroxybutyrate or derivatives or prodrugs of gamma-hydroxybutyrate, or ketamine in order to detect the aforementioned molecules.

The article of the disclosure may be used for the detection of a drug in a liquid medium, which, in certain embodiments of the invention may be water, an aqueous medium, an alcoholic medium or an organic medium. For example, the liquid medium may be a beverage such as water, an alcoholic beverage, a non-alcoholic beverage, a soft drink, a fruit juice, or a hot beverage. Where the article is used to detect a drug in an alcoholic beverage, the alcoholic beverage may be a liqueur, cocktail or fermented beverage such as wine, beer or ale.

When considering the composition of the article, one embodiment includes nanoparticles that are gold or silver and photochromic optical switch molecules that may include spiropyran or gold nanoparticles. In addition, the use of acrylic acid and its derivatives may enable colorimetric readout by driving the isomerization equilibrium of the photochromic optical switch molecules. Therefore, in certain embodiments, the composition of the article may further comprise acrylic acid or its derivatives thereof including acrylic acid esters, such as ethyl acrylate, butyl acrylate, 2-ethylhexyl acrylate, sorbyl acrylate, 2-(dimethylamino)-ethyl acrylate, 3,3-dimethoxypropyl acrylate, 2,2,3,3,4,4,4-heptafluorobutyl acrylate, 2-cyanoethyl acrylate, 4-tluorophenyl acrylate, chloroethyl acrylate, 2-(propen-1-yloxy)-ethyl acrylate, phenyl acrylate, allyl acrylate, hydroxyethylmethacrylate (HEMA), acrylamides, such as N,N-dimethylacrylamide, and acrylonitrile.

In certain embodiments, the polymer may be a polymer or a co-polymer including one or more polymerizable monomers such as 2-ethylphenoxy acrylate, 2-ethylphenoxy methacrylate, 2-ethylthiophenyl acrylate, 2-ethylthiophenyl methacrylate, 2-ethylaminophenyl acrylate, 2-ethylaminophenyl methacrylate, phenyl acrylate, phenyl methacrylate, benzyl acrylate, benzyl methacrylate, 2-phenylethyl acrylate, 2-phenylethyl, methacrylate, 3-phenylpropyl acrylate, 3-phenylpropyl methacrylate, 3-propylphenoxy acrylate, 3-propylphenoxy methacrylate, 4-butylphenoxy acrylate, 4-butylphenoxy methacrylate, 4-phenylbutyl acrylate, 4-phenylbutylmethacrylate, 4-methylphenylacrylate, 4-methylphenyl methacrylate, 4-methylbenzylacrylate, 4-methylbenzylmethacrylate, 2-2-methylphenylethyl acrylate, 2-2-methylphenylethylmethacrylate, 2-3-methylphenylethylacrylate, 2-3-methylphenylethylmethacrylate, 2-4-methylphenylethylacrylate, 2-4-methylphenylethyl methacrylate, 2-(4-propylphenyl)ethyl acrylate, 2-(4-propylphenyl)ethylmethacrylate, 2-(4-(1-methylethyl)phenyl)ethylacrylate, 2-(4-(1-methylethyl)phenyl)ethylmethacrylate, 2-(4-methoxyphenyl)ethylacrylate, 2-(4-methoxyphenyl)ethylmethacrylate, 2-(4-cyclohexylphenyl)ethylacrylate, 2-(4-cyclohexylphenyl)ethylmethacrylate, 2-(2-chlorophenyl)ethylacrylate, 2-(2-chlorophenyl)ethylmethacrylate, 2-(3-chlorophenyl)ethyl acrylate, 2-(3-chlorophenyl)ethylmethacrylate, 2-(4-chlorophenyl)ethylacrylate, 2-(4-chlorophenyl)ethylmethacrylate, 2-(4-bromophenyl)ethylacrylate, 2-(4-bromophenyl)ethyl methacrylate, 2-(3-phenylphenyl)ethylacrylate, 2-(3-phenylphenyl)ethylmethacrylate, 2-(4-phenyl phenyl)ethylmethacrylate, 2-(4-phenylphenyl)ethylmethacrylate, 2-(4-benzylphenyl)ethyl acrylate, and 2-(4-benzylphenyl)ethyl methacrylate.

In certain other embodiments, the polymer is a polymer or a co-polymer including one or more polymerizable monomers, such as benzyl acrylate, phenyl acrylate, naphthyl acrylate, pentabromophenyl acrylate, 2-phenoxyethyl acrylate, 2-phenoxyethyl methacrylate, and 2,3-dibromopropyl acrylate, n-butyl acrylate, n-hexyl acrylate, 2-ethylhexyl acrylate, 2-ethoxyethyl acrylate, 2,3-dibromopropyl acrylate, 1-dihydroperfluorobutyl acrylate, 2-hydroxyethyl acrylate, 2-hydroxyethyl methacrylate, 3-hydroxypropyl acrylate, 3-hydroxypropyl methacrylate, 4-hydroxybutyl acrylate, 4-hydroxybutyl methacrylate, 2,3-dihydroxypropyl acrylate, 2,3-dihydroxypropyl methacrylate, N-methyl acrylamide, N-ethyl acrylamide, N-propyl acrylamide, N-isopropylacrylamide, N-butyl acrylamide, methacrylic acid, 2-hydroxyethyl acrylate, 2-hydroxyethyl methacrylate, 2-N-ethylacrylate pyrrolidone, 2-hydroxy-3-phenoxypropyl acrylate, 2,3-dihydroxypropyl acrylate, 2,3-dihydroxypropyl methacrylate, 2-N-vinyl pyrrolidone, polyethylene oxide, hydroxyethylmethacrylate and methyl methacrylate, vinyl pyrrolidone and hydroxyethylmethacrylate, vinyl pyrrolidone and methyl methacrylate, glyceral methacrylate and methyl methacrylate, glyceryl-methacrylate and 2-hydroxyethylmethacrylate, hydroxyethylmethacrylate or diacetone acyl amide and hydroxyalkyl methacrylates, hydroxyethylmethacrylate or diacetone acyl amide and acrylates with the alkyl groups having from 2 to 6 carbon atoms, hydroxyethylmethacrylate or diacetone acyl amide and vinyl hydroxyl acetate, hydroxyethylmethacrylate or diacetone acyl amide and vinyl hydroxy propionate, hydroxyethylmethacrylate or diacetone acyl amide and vinyl hydroxy butyrate, hydroxyethylmethacrylate or diacetone acyl amide and N-vinyllactams namely N-vinyl pyrrolidone, N-vinyl caprolactam and N-vinyl piperidone, hydroxyethylmethacrylate or diacetone acyl amide and N,N dialkyl amino ethyl methacrylates and acrylates with the alkyl groups having from 0 to 2 carbon atoms, hydroxyethylmethacrylate or diacetone acyl amide and hydroxyalkyl vinyl ethers with the alkyl groups having 2 to 4 carbon atoms, hydroxyethylmethacrylate or diacetone acyl amide and 1-vinyloxy 2-hydroxyethylene, hydroxyethyl methacrylate or diacetone acyl amide and 1-vinyloxy 5-hydroxy 3-oxapentane, hydroxyethylmethacrylate or diacetone acyl amide and 1-vinyloxy 8-hydroxy 3,6-dioxaoctane, hydroxyethylmethacrylate or diacetone acyl amide and 1-vinyloxy 14-hydroxy 3,6,9,12 tetraoxatetradectane, hydroxyethylmethacrylate or diacetone acyl amide and N-vinyl morpholine; hydroxyethylmethacrylate or diacetone acyl amide and N,N dialkyl acrylamide with the alkyl groups having from 0 to 2 carbons atoms, hydroxyethylmethacrylate or diacetone acyl amide and alkyl vinyl ketone with the alkyl group having 1 to 2 carbon atoms, hydroxyethylmethacrylate or diacetone acyl amide and N-vinyl succinimide or N-vinyl glutarimide, hydroxyethylmethacrylate or diacetone acyl amide and N-vinyl imidazole, and hydroxyethylmethacrylate or diacetone acyl amide and N-vinyl 3-morpholinone.

The disclosure further encompasses a method for the detection of illicit substances. The method may include contacting a sample that includes a drug in a liquid medium with the article. In one aspect, a color change of the article indicates the presence of the drug in the liquid medium. In carrying out the method, the article may be in the form of a straw, a beverage stirring bar, a cutlery, a beverage coaster, a placemat or a pen. Furthermore, the article may be attached to a second article in the form of a liquid medium carrier, a glass of beverage, a cup, a bowl, a dish, a straw, a beverage stirring bar, a cutlery, a cocktail napkin, a beverage coaster, a placemat, a menu, a personal card or a pen.

The manufacture of molecularly imprinted polymer devices has been described elsewhere. Said references include US2012/0214252 (Knop, et al.), U.S. Pat. No. 8,241,575 (Murray, et al.) and Ser. No. 61/715,994 (Knop, et al.), WO 2013019605 A2 PCT/US2012/048511 (Perez-Luna, et al.) and PCT/US/2013/065415 (Knop et al.) all of which are herein incorporated by reference in their entirety.

Detection of molecular shape changes in MIPs in the presence of analyte binding has been investigated by use of resulting spatial differences of immobilized Au nanoparticles in a Au-MIP composite (See, specifically, Diagram 2A-B in Matsui et al., Analytic Chemistry (2004) 76: 1310-1315)

The molecularly imprinted crosslinked polymer according to the present invention may be prepared by an olefin metathesis crosslinking reaction of the core, crosslinker and a Grubbs catalyst as is well known in the art. Examples of such metathesis catalysts have been previously described in, for example, U.S. Pat. Nos. 5,312,940; 5,342,909; 5,831,108; 5,969,170; 6,111,121; 6,211,391; 5,917,071; 5,977,393; and 6,225,488 and PCT Publications WO 98/39346, WO 99/00396, WO 99/00397, WO 99/28330, WO 99/29701, WO 99/50330, WO 99/51344, WO 00/15339, WO 00/58322 and WO 00/71554, the disclosures of each of which are incorporated herein by reference to the extent relevant.

### Example I

To make elastic polymers for colorimetric detection, the chemicals for colorimetric detection include 3.556 g Acrylamide, 0.0786 g Calcium Chloride, 0.00213 g N,N Methylene bisacrylamide, 6 mg 4,4 Azobis(4cyanovaleric acid), 10 ml DI Water, A separate polyacrylic acid solution includes 3 ml DI Water, 0.350 ml Acrylic Acid and 6 mg initiator. Both the polymer and polyacrylic acid solution were sonicated for mixing. The polyacrylic acid solution was then polymerized with UV. The resulting polyacrylic acid mixture (linearly polymerized) was added to the polymer mixture to form the elastic polymer solution. Three stock samples were made (S1, S2, and S3). From each stock sample, three 2 ml samples of elastic polymers were polymerized. MIP elastic polymers were also created by formulating the elastic polymer solution, with the addition of disodium succinate and acrylic acid (about 10 mg and 90 uL respectively, in a 5 ml polymer solution). NIP samples were prepared using the above polymer composition. The polymer was incubated in a SP solution. After the polymer color became consistent with the SP solution color, the excess solution was discarded. A disodium succinate solution was then added to the polymers. The polymers were left to incubate in the DS solution for at least 1 hr. Detection was indicated by the polymer turning from yellow to pink upon interaction with the disodium succinate solution.

As comparison, three sets of elastic polymers were made. The first set of elastic polymers was made in the absence of colorimetric detection (FIG. 27A-C). The second set of elastic polymers comprising all the chemicals of NIPs in the absence of the analyte of disodium succinate was made (FIG. 27D-F). The last set of elastic polymers comprising all the chemicals of NIPs in the presence of the analyte of disodium succinate were made (FIG. 27G-I).

As shown in FIG. 27A-C, in the absence of colorimetric detection, the elastic hydrogel appears to be colorless. After the addition of all the chemicals of NIPs, the elastic hydrogel shows a yellow color (FIG. 27D-F). Upon further addition of an analyte of disodium succinate, the elastic hydrogel appears to be pink. Further, it appears that the elastic properties of the hydrogel were maintained after the addition of NIP chemicals (FIG. 27E-F) and the analyte of disodium succinate (FIG. 27H-I). These observations demonstrate that colorimetric detection of the present invention may be easily combined with elastic polymers and elastic hydrogels. The pink elastic hydrogel after the addition of the SP solution indicates the formation of MIPs as discussed above.

What is claimed is:

1. An article for the detection of a drug in a liquid medium, comprising:
(a) a polymer having pores specifically imprinted to provide for capture of a drug in said pores;
(b) nanoparticles; and
(c) photochromic optical switch molecules,
wherein capture of said drug in the pores of the polymer results in a change in the spatial relation of the nanoparticles in the polymer, causing the photochromic optical switch molecules to undergo a change in energy state which corresponds to a change in spectra of said photochromic optical switch molecules, thereby providing detection of the drug.

2. The article of claim 1, wherein the detection of said drug is provided by a color change of the article.

3. The article of claim 1, wherein the pores are specifically imprinted to provide for capture of a drug, and wherein said drug is a recreational drug or illicit drug.

4. The article of claim 3, wherein said drug is a depressant, an antihistamine, an analgesic, a tranquilizer, a hallucinogen, a psychedelic, a deliriant or a stimulant.

5. The article of claim 1, wherein said drug is selected from amobarbital, aprobarbital, alphenal, barbital, brallobarbital, phenobarbital, alprazolam, bretazenil, bromazepam, brotizolam, chlordiazepoxide, cinolazepam, clonazepam, clorazepate, clotiazepam, cloxazolam, delorazepam, diazepam, estazolam, etizolam, flurazepam, flutoprazepam, halazepam, ketazolam, loprazolam, lorazepam, lormetazepam, medazepam, midazolam, nimetazepam, nitrazepam, nordazepam, oxazepam, phenazepam, pinazepam, prazepam, premazepam, quazepam, temazepam, tetrazepam, triazolam, ipratropium bromide, oxitropium bromide, tiotropium, glycopyrrolate, oxybutinin, tolterodine, azelastine cetirizine, cyclizine, chlorpheniramine, clemastine, desloratadine, dexchlorpheniramine, dimenhydrinate, dimetindene, diphenhydramine, doxylamine, ebastine, embramine, fexofenadine, levocetirizine, loratadine, meclozine, olopatadine, pheniramine, promethazine, quetiapine, rupatadine, cimetidine, famotidine, lafutidine, nizatidine, ranitidine, roxatidine, paracetamol, and non-steroidal anti-inflammatory drugs (NSAIDs).

6. The article of claim 1, wherein said drug is selected from benzodiazepine, nonbenzodiazepine, carisoprodol, chloral hydrate, diethyl ether, ethchlorvynol, gabapentin, gamma-butyrolactone (GBL), gamma-hydroxybutyrate (GHB), glutethimide, kava, kavalactones meprobamate, methaqualone, pregabalin, propofol, theanine, valerian, atropine, dimenhydrinate, diphenhydramine, hyoscyamine, scopolamine, myristicin, ibotenic acid, muscimol, dextromethorphan, dextromethorphan, chlorpheniramine, ketamine, methoxetamine, phencyclidine, nitrous oxide, phenethylamines, MDMA, mescaline, tryptamines, alpha-methyltryptamine, bufotenin, dimethyltryptamine, lysergic acid amide, lysergic acid diethylamide, psilocin, psilocybin, ibogaine, salvinorin A, sympathomimetics, Entactogens, arecoline, rauwolscine and yohimbine.

7. The article of claim 1, wherein said drug is selected from caffeine, tetrahydrocannabinol (THC), hydrocodone, oxycodone, morphine, diacetylmorphine, cocaine, lidocaine and novocaine.

8. The article of claim 1, wherein said drug is selected from gamma-hydroxybutyrate, derivatives of gamma-hydroxybutyrate, prodrugs of gamma-hydroxybutyrate, and ketamine.

9. The article of claim 1, wherein said liquid medium is selected from water, an aqueous medium, an alcoholic medium, and an organic medium.

10. The article of claim 1, wherein said liquid medium is a beverage.

11. The article of claim 1, wherein said nanoparticles are gold or silver nanoparticles.

12. The article of claim 1, wherein said photochromic optical switch molecules comprise at least one of spiropyran and gold nanoparticles.

13. The article of claim 1, further comprising one of acrylic acid and a derivative of acrylic acid.

14. The article of claim 13, wherein the derivative of acrylic acid includes one of acrylic acid esters, such as ethyl acrylate, butyl acrylate, 2-ethylhexyl acrylate, sorbyl acrylate, 2-(dimethylamino)-ethyl acrylate, 3,3-dimethoxypropyl acrylate, 2,2,3,3,4,4,4-heptafluorobutyl acrylate, 2-cyanoethyl acrylate, 4-tluorophenyl acrylate, chloroethyl acrylate, 2-(propen-1-yloxy)-ethyl acrylate, phenyl acrylate, allyl acrylate, hydroxyethylmethacrylate (HEMA), acrylamides, such as N,N-dimethylacrylamide, and acrylonitrile.

15. The article of claim 13, wherein colorimetric readout is enabled by driving the isomerization equilibrium of the photochromic optical switch molecules.

16. The article of claim 1, wherein said polymer includes at least one polymerizable monomer selected from the group consisting of 2-ethylphenoxy acrylate, 2-ethylphenoxy methacrylate, 2-ethylthiophenyl acrylate, 2-ethylthiophenyl methacrylate, 2-ethylaminophenyl acrylate, 2-ethylaminophenyl methacrylate, phenyl acrylate, phenyl methacrylate, benzyl acrylate, benzyl methacrylate, 2-phenylethyl acrylate, 2-phenylethyl, methacrylate, 3-phenylpropyl acrylate, 3-phenylpropyl methacrylate, 3-propylphenoxy acrylate, 3-propylphenoxy methacrylate, 4-butylphenoxy acrylate, 4-butylphenoxy methacrylate, 4-phenylbutyl acrylate, 4-phenylbutyl methacrylate, 4-methylphenyl acrylate, 4-methylphenyl methacrylate, 4-methylbenzyl acrylate, 4-methylbenzyl methacrylate, 2-2-methylphenylethyl acrylate, 2-2-methylphenylethyl methacrylate, 2-3-methylphenylethyl acrylate, 2-3-methylphenylethyl methacrylate, 2-4-methylphenylethyl acrylate, 2-4-methylphenylethyl methacrylate, 2-(4-propylphenyl)ethyl acrylate, 2-(4-propylphenyl)ethyl methacrylate, 2-(4-(1-methylethyl)phenyl)ethylacrylate, 2-(4-(1-methylethyl)phenyl)ethyl methacrylate, 2-(4-methoxyphenyl)ethyl acrylate, 2-(4-methoxyphenyl)ethyl methacrylate, 2-(4-cyclohexylphenyl)ethyl acrylate, 2-(4-cyclohexylphenyl) ethyl methacrylate, 2-(2-chlorophenyl)ethyl acrylate, 2-(2-chlorophenyl)ethyl methacrylate, 2-(3-chlorophenyl) ethyl acrylate, 2-(3-chlorophenyl)ethyl methacrylate, 2-(4-chlorophenyl)ethyl acrylate, 2-(4-chlorophenyl)ethylmethacrylate, 2-(4-bromophenyl)ethyl acrylate, 2-(4-bromophenyl)ethyl methacrylate, 2-(3-phenylphenyl)ethyl acrylate, 2-(3-phenylphenyl)ethyl methacrylate, 2-(4-phenylphenyl) ethyl methacrylate, 2-(4-phenylphenyl)ethyl methacrylate, 2-(4-benzylphenyl)ethyl acrylate, and 2-(4-benzylphenyl)ethyl methacrylate.

17. The article of claim 1, wherein said polymer includes at least one polymerizable monomers selected from the group consisting of benzyl acrylate, phenyl acrylate, naphthyl acrylate, pentabromophenyl acrylate, 2-phenoxyethyl acrylate, 2-phenoxyethyl methacrylate, and 2,3-dibromopropyl acrylate, n-butyl acrylate, n-hexyl acrylate, 2-ethylhexyl acrylate, 2-ethoxyethyl acrylate, 2,3-dibromopropyl acrylate, 1-dihydroperfluorobutyl acrylate, 2-hydroxyethyl acrylate, 2-hydroxyethyl methacrylate, 3-hydroxypropyl acrylate, 3-hydroxypropyl methacrylate, 4-hydroxybutyl acrylate, 4-hydroxybutyl methacrylate, 2,3-dihydroxypropyl acrylate, 2,3-dihydroxypropyl methacrylate, N-methyl acrylamide, N-ethyl acrylamide, N-propyl acrylamide, N-isopropylacrylamide, N-butyl acrylamide, methacrylic acid, 2-hydroxyethyl acrylate, 2-hydroxyethyl methacrylate, 2-N-ethylacrylate pyrrolidone, 2-hydroxy-3-phenoxypropyl acrylate, 2,3-dihydroxypropyl acrylate, 2,3-dihydroxypropyl methacrylate, 2-N-vinyl pyrrolidone, polyethylene oxide, hydroxyethylmethacrylate and methyl methacrylate, vinyl pyrrolidone and hydroxyethylmethacrylate, vinyl pyrrolidone and methyl methacrylate, glyceral methacrylate and methyl methacrylate, glyceryl-methacrylate and 2-hydroxyethylmethacrylate, hydroxyethylmethacrylate or diacetoneacyl amide and hydroxyalkyl methacrylates, hydroxyethylmethacrylate or diacetone acyl amide and acrylates with the alkyl groups having from 2 to 6 carbon atoms, hydroxyethylmethacrylate or diacetone acyl amide and vinyl hydroxyl acetate, hydroxyethylmethacrylate or diacetone acyl amide and vinyl hydroxy propionate, hydroxyethylmethacrylate or diacetone acyl amide and vinyl hydroxy butyrate, hydroxyethylmethacrylate or diacetone acyl amide and N-vinyllactams namely N-vinyl pyrrolidone, N-vinyl caprolactam and N-vinyl piperidone, hydroxyethylmethacrylate or diacetone acyl amide and N,N dialkyl amino ethyl methacrylates and acrylates with the alkyl groups having from 0 to 2 carbon atoms, hydroxyethylmethacrylate or diacetone acyl amide and hydroxyalkyl vinyl ethers with the alkyl groups having 2 to 4 carbon atoms, hydroxyethylmethacrylate or diacetone acyl amide and 1-vinyloxy 2-hydroxyethylene, hydroxyethyl methacrylate or diacetone acyl amide and 1-vinyloxy 5-hydroxy 3-oxapentane, hydroxyethylmethacrylate or diacetone acyl amide and 1-vinyloxy 8-hydroxy 3,6-dioxaoctane, hydroxyethylmethacrylate or diacetone acyl amide and 1-vinyloxy 14-hydroxy 3,6,9,12 tetraoxatetradectane, hydroxyethylmethacrylate or diacetone acyl amide and N-vinyl morpholine; hydroxyethylmethacrylate or diacetone acyl amide and N,N dialkyl acrylamide with the alkyl groups having from 0 to 2 carbons atoms, hydroxyethylmethacrylate or diacetone acyl amide and alkyl vinyl ketone with the alkyl group having 1 to 2 carbon atoms, hydroxyethylmethacrylate or diacetone acyl amide and N-vinyl succinimide or N-vinyl glutarimide, hydroxyethylmethacrylate or diacetone acyl amide and N-vinyl imidazole, and hydroxyethylmethacrylate or diacetone acyl amide and N-vinyl 3-morpholinone.

18. The article of claim 1, wherein the article is in the form of one of a straw, a beverage stirring bar, a cutlery, a beverage coaster, a placemat and a pen.

19. The article of claim 1, wherein the article is attached to one of a liquid medium carrier, a glass of beverage, a cup, a bowl, a dish, a straw, a beverage stirring bar, a cutlery, a cocktail napkin, a beverage coaster, a placemat, a menu, a personal card and a pen.

20. A method for the detection of illicit substances comprising contacting a sample that includes a drug in a liquid medium with an article comprising:
(a) a polymer having pores specifically imprinted to provide for capture of a drug in said pores;
(b) nanoparticles; and
(c) photochromic optical switch molecules,
wherein a color change of said article indicates the presence of said drug in said liquid medium.
